(19) United States
(12) Patent Application Publication
(10) Pub. No.: US 2014/0071247 A1
(43) Pub. Date: Mar. 13, 2014

(54) IMAGE PICK-UP DEVICE AND DISTANCE MEASURING DEVICE

(71) Applicant: PANASONIC CORPORATION, Osaka (JP)

(72) Inventors: Norihiro Imamura, Osaka (JP); Tsuguhiro Korenaga, Osaka (JP); Michihiro Yamagata, Osaka (JP); Atsushi Morimuar, Kanagawa (JP); Kenya Uomori, Osaka (JP)

(21) Appl. No.: 14/009,251

(22) PCT Filed: Feb. 1, 2013
(86) PCT No.: PCT/JP2013/000565

§ 371 Date: Oct. 1, 2013

(30) Foreign Application Priority Data
Feb. 3, 2012 (JP) 2012-021695

(51) Int. Cl. G01C 11/02; H04N 13/02

(52) U.S. Cl. CPC G01C 11/02; H04N 13/0225
USPC 348/49; 349/15

(57) ABSTRACT

An image pickup device N according to an embodiment includes: an objective lens L with first and second regions D1, D2; an image sensor N with multiple groups of pixels Pg, in each of which first, second, third and fourth pixels P1 to P4 are arranged in two rows and two columns on an image capturing plane Ni; and an array of optical elements K which includes a plurality of optical elements M. The first and second pixels P1, P2 have a first spectral transmittance characteristic, and in each group of pixels Pg, the first and second pixels P1, P2 are arranged at mutually different positions in the second direction. Each of the plurality of optical elements M is arranged at such a position as to face groups of pixels Pg that are arranged in a row in the first direction among the multiple groups of pixels Pg.

### TECHNICAL FIELD

The present application relates to an image pickup device such as a camera and also relates to a distance measuring device.

### BACKGROUND ART

Recently, an image pickup device to produce stereoscopic images of a subject using a plurality of imaging optical systems has been used in actual products of digital still cameras, movie cameras, endoscope cameras for medical inspection and treatment and various other cameras. Meanwhile, a distance measuring device has been used as a device for determining the distance to an object (i.e., the object of range finding) based on parallax between multiple imaging optical systems. Specifically, such a device has been used to determine the distance between running cars and as a member of an autofocusing system for cameras or a three-dimensional shape measuring system.

Such an image pickup device obtains a left-eye image and a right-eye image using two imaging optical systems which are arranged side by side horizontally. On the other hand, such a distance measuring device determines the distance to the object by carrying out triangulation based on the parallax between the left- and right-eye images.

Such an image pickup device or distance measuring device needs to use two image capturing sections, and therefore, the overall size of the device and its manufacturing cost will both increase, which is a problem.

Thus, to overcome such a problem, an image pickup device which obtains stereoscopic images using a single imaging optical system has been disclosed (in Patent Documents Nos. 1 and 2, for example).

### CITATION LIST

### Patent Literature

Patent Document No. 1: Japanese Laid-Open Patent
Patent Document No. 2: PCT International Application Japanese National-Phase Patent Publication No. 2011-515045

### SUMMARY OF INVENTION

### Technical Problem

Contrary to these conventional technologies, however, there is an increasing demand for an image pickup device that can obtain an image with an even higher resolution without using a dedicated image sensor.

A non-limiting exemplary embodiment of the present application provides an image pickup device which can obtain an image with an even higher resolution without using any dedicated image sensor.

### Solution to Problem

An image pickup device according to an aspect of the present invention includes: a lens optical system which includes a first pupil region and a second pupil region that is different from the first pupil region; an image sensor with multiple groups of pixels, in each of which first, second, third and fourth pixels, on which light that has passed through the lens optical system is incident, are arranged in two rows and two columns on an image capturing plane; and an array of optical elements which is arranged between the lens optical system and the image sensor and which includes a plurality of optical elements. The multiple groups of pixels are arranged in first and second directions on the image capturing plane. The first and second pixels have a first spectral transmittance characteristic, the third pixel has a second spectral transmittance characteristic, the fourth pixel has a third spectral transmittance characteristic, and in each group of pixels, the first and second pixels are arranged at mutually different positions in the second direction. In the array of optical elements, each of the plurality of optical elements is arranged at such a position as to face groups of pixels that are arranged in a row in the first direction among the multiple groups of pixels.

### Advantageous Effects of Invention

An image pickup device according to an aspect of the present invention can obtain high-resolution color images for stereoscopic viewing using a single image pickup system. In addition, since an image sensor with an ordinary Bayer arrangement can be used, the initial equipment cost can be cut down.

### BRIEF DESCRIPTION OF DRAWINGS

FIG. 1 A schematic representation illustrating a first embodiment of an image pickup device A according to the present invention.

FIG. 2 A front view of regions D1 and D2 according to an embodiment of the present invention as viewed from the subject side.

FIG. 3 A perspective view of an array of optical elements K according to the first embodiment of the present invention.

FIG. 4 (a) is an enlarged view of the array of optical elements K and image sensor N shown in FIG. 1 and (b) shows the relative positions of the array of optical elements K and pixels on the image sensor N.

FIG. 5 Shows a flow in which first and second color images are generated according to the first embodiment of the present invention.

FIG. 6 Illustrates how to calculate an SAD according to the first embodiment of the present invention.

FIG. 7 (a) to (d) show extracted pixels on which light beams that have passed through the first and second regions impinge according to the first embodiment of the present invention.

FIG. 8 Shows alternative relative positions of the array of optical elements K and pixels on the image sensor N according to the first embodiment of the present invention.

FIGS. 9 (a) and (b) are enlarged views of an array of optical elements K and image sensor N according to a second embodiment of the present invention.

FIGS. 10 (a) and (b) are front views of regions D1 and D2 according to a third embodiment of the present invention as viewed from the subject side.

FIG. 11 (a) to (c) are front views of regions D1 and D2 according to a fourth embodiment of the present invention as viewed from the subject side.

FIG. 12 A cross-sectional view of a liquid crystal shutter array according to a fourth embodiment of the present invention.

FIGS. 13 (a1) to (e1) are front views of regions D1 and D2 according to a fifth embodiment of the present invention as viewed from the subject side and (a2) to (e2) are graphs showing the relative transmittances of the regions D1 and D2.

FIGS. 14 (a) and (b) are schematic representations illustrating optical systems according to a sixth embodiment of the present invention.

FIG. 15 A schematic representation illustrating an optical system according to a seventh embodiment of the present invention.

FIG. 16 A schematic representation illustrating an eighth embodiment of an image pickup device A according to the present invention.

FIGS. 17 (a) and (b) illustrate conceptually the principle of rangefinding according to the eighth embodiment of the present invention.

FIG. 18 (a) illustrates, on a larger scale, an image capturing plane and its surrounding members in a situation where crosstalk is produced according to an embodiment of the present invention and (b) illustrates, on a larger scale, an image capturing plane and its surrounding members in a situation where the crosstalk has been reduced.

FIG. 19 Illustrates an alternative arrangement of filters on an image sensor according to another embodiment of the present invention.

FIGS. 20 (a) and (b) illustrate relative positions of an array of optical elements K and pixels on an image sensor N in a comparative example.

FIGS. 21 (a) and (b) show extracted pixels on which light beams that have passed through first and second regions impinge in the comparative example.

### DESCRIPTION OF EMBODIMENTS

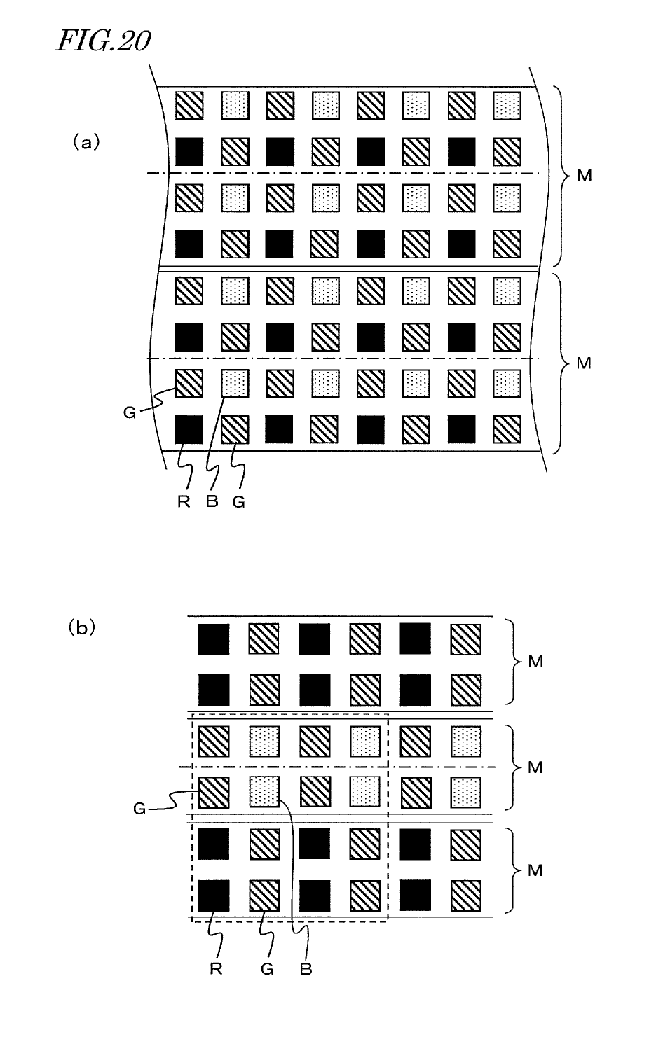

The present inventors checked out the image pickup devices disclosed in Patent Documents Nos. 1 and 2. As a result, we discovered that although Patent Documents Nos. 1 and 2 do disclose an embodiment that uses a color image sensor with an existent Bayer arrangement, each of those patent documents adopts an arrangement in which a single optical element of a lenticular lens covers four columns of pixels as shown in FIG. 20(a), thus resulting in a significantly decreased resolution.

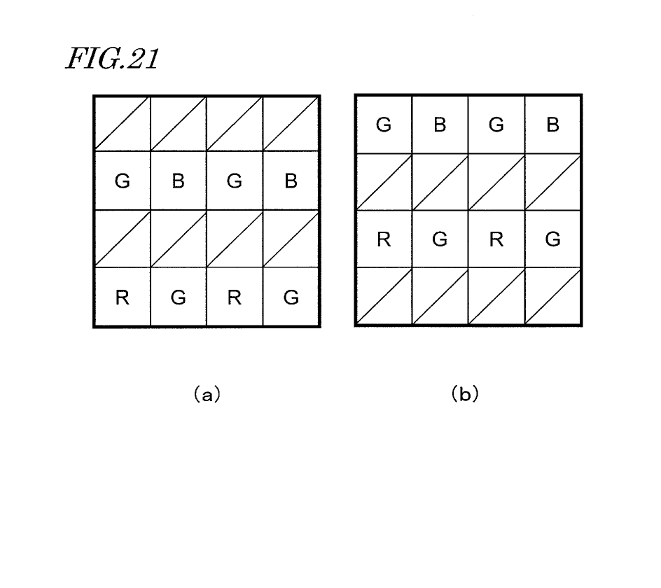

In another example, Patent Document No. 2 adopts an arrangement in which a single optical element of a lenticular lens covers two columns of pixels as shown in FIG. 20(b). However, if information about a right-eye image and information about a left-eye image are extracted from the dotted line area, the results will be as shown in FIGS. 21(a) and 21(b). Each pixel provides information about only one color and information about some colors is missing. Such missing color information is ordinarily generated by making interpolation on surrounding pixels, thus causing a decrease in resolution. On top of that, an additional image sensor with a dedicated color filter arrangement is also needed, and therefore, photomasks and additional means for forming such dedicated color filters have to be used. As a result, initial equipment cost increases compared to a situation where just a color image sensor with an existent Bayer arrangement is used.

Thus, to overcome such a problem, the present inventors invented a novel image pickup device which can obtain high-resolution color images for stereoscopic viewing using a single imaging optical system. An aspect of the present invention may be outlined as follows.

An image pickup device according to an aspect of the present invention includes: a lens optical system which includes a first pupil region and a second pupil region that is different from the first pupil region; an image sensor with multiple groups of pixels, in each of which first, second, third and fourth pixels, on which light that has passed through the lens optical system is incident, are arranged in two rows and two columns on an image capturing plane; and an array of optical elements which is arranged between the lens optical system and the image sensor and which includes a plurality of optical elements. The multiple groups of pixels are arranged in first and second directions on the image capturing plane. The first and second pixels have a first spectral transmittance characteristic, the third pixel has a second spectral transmittance characteristic, the fourth pixel has a third spectral transmittance characteristic, and in each group of pixels, the first and second pixels are arranged at mutually different positions in the direction. In the array of optical elements, each of the plurality of optical elements is arranged at such a position as to face groups of pixels that are arranged in a row in the first direction among the multiple groups of pixels.

On a plane which is parallel to the image capturing plane of the image sensor, the first and second pupil regions may be arranged at mutually different positions in the second direction.

The array of optical elements may make light that has passed through the first pupil region incident on the first and third pixels and may also make light that has passed through the second pupil region incident on the second and fourth pixels.

The image pickup device may further include a signal processing section. The signal processing section may receive first and second pieces of image information that have been generated by the first and second pixels, respectively, may extract the magnitude of parallax between the first and second pieces of image information, and may generate first and second color images with parallax based on the first, second, third and fourth pixels and the magnitude of parallax.

The image pickup device may generate the first and second color images by shifting, by the magnitude of parallax, third and fourth pieces of image information that have been generated by the third and fourth pixels.

The first color image may include, as its components, the first piece of image information, the third piece of image information, and a piece of image information obtained by shifting the fourth piece of image information by the magnitude of parallax, and the second color image may include, as its components, the second piece of image information, the fourth piece of image information, and a piece of image information obtained by shifting the third piece of image information by the magnitude of parallax.

The image pickup device may generate the first and second color images by shifting, by the magnitude of parallax, the first, second, third and fourth pieces of image information that have been generated by the first, second, third and fourth pixels, respectively.

The first color image may include, as its components, the first piece of image information, the third piece of image information, and a piece of image information obtained by shifting the second and fourth pieces of image information by the magnitude of parallax, and the second color image may include, as its components, the second piece of image information, the fourth piece of image information, and a piece of image information obtained by shifting the first and third pieces of image information by the magnitude of parallax.

The first, second, third and fourth pixels of the image sensor may be arranged in a Bayer arrangement pattern.

The first and second pupil regions may have been divided using the optical axis of the lens optical system as the center of their boundary.

The array of optical elements may be a lenticular lens.

The array of optical elements may be a micro lens array. Each of the plurality of optical elements may include a plurality of micro lenses that are arranged in the first direction. And each of the plurality of micro lenses may be arranged at such a position as to face two pixels that are arranged in the second direction.

The lens optical system may be an image-space telecentric optical system.

The lens optical system may be an image-space non-telecentric optical system, and the arrangement of the array of optical elements may be offset with respect to the arrangement of pixels of the image sensor outside of the optical axis of the lens optical system.

The array of optical elements may have been formed on the image sensor.

The image pickup device may further include a micro lens which is arranged between the array of optical elements and the image sensor, and the array of optical elements may have been formed over the image sensor with the micro lens interposed.

The image pickup device may further include a liquid crystal shutter array which changes the positions of the first and second pupil regions.

Each of liquid crystal shutters in the liquid crystal shutter array may have a variable transmittance.

The lens optical system may further include reflective members 1A and 1B which make light incident on the first pupil region and reflective members 2A and 2B which make light incident on the second pupil region.

The image pickup device may further include a relay optical system.

The image pickup device may further include a stop, which may make light that has come from the subject incident on the first and second pupil regions.

A distance measuring device according to an aspect of the present invention includes: an image pickup device according to any of the embodiments described above; and a second signal processing section which measures the distance to the subject.

An image pickup system according to an aspect of the present invention includes an image pickup device according to any of the embodiments described above and a signal processor. The signal processor receives first and second pieces of image information that have been generated by the first and second pixels, respectively, extracts the magnitude of parallax between the first and second pieces of image information, and generates first and second color images with parallax based on the first, second, third and fourth pixels and the magnitude of parallax.

Hereinafter, embodiments of an image pickup device according to the present invention will be described with reference to the accompanying drawings.

### Embodiment 1

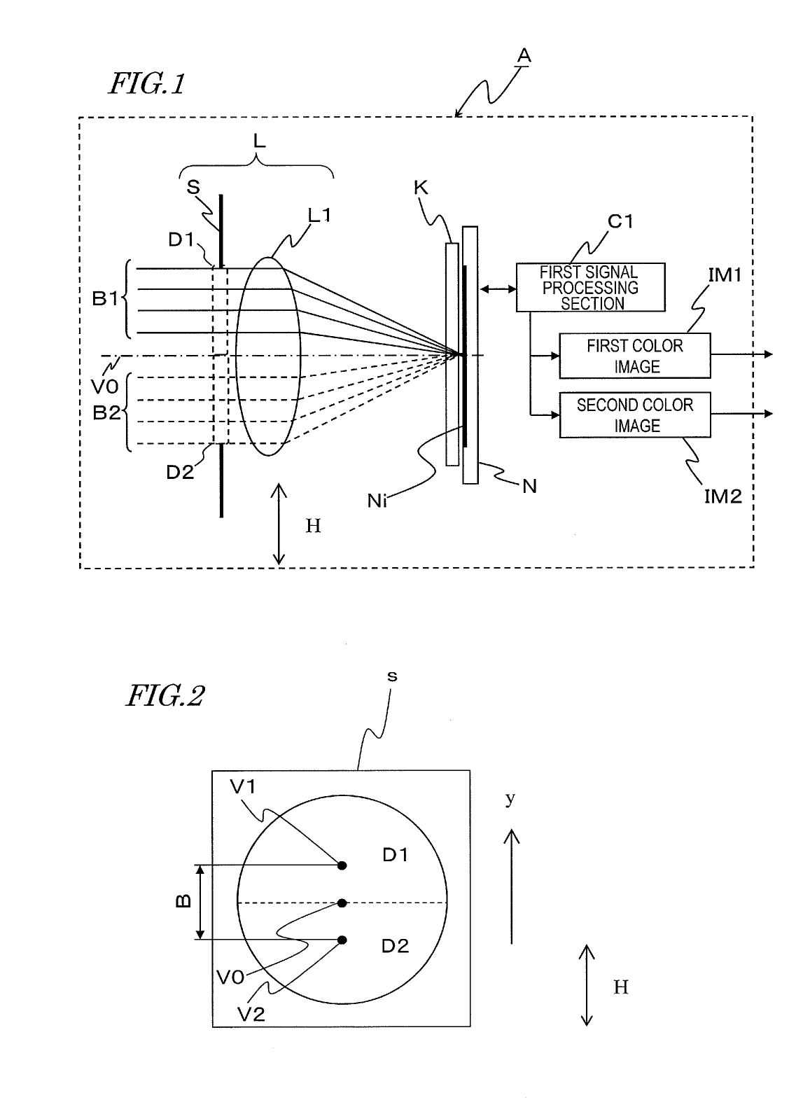

FIG. 1 is a schematic representation illustrating an image pickup device A as a first embodiment. The image pickup device A of this embodiment includes a lens optical system L, of which the optical axis is identified by V0, an array of optical elements K which is arranged in the vicinity of the focal point of the lens optical system L, an image sensor N, and a first signal processing section C1.

The lens optical system L includes a stop S and an objective lens L1 that light that has passed through the stop S enters. The lens optical system L has a region (pupil region) D1 and another region (pupil region) D2 which is arranged at a different position from the region D1. As shown in FIG. 1, these regions D1 and D2 are defined by dividing the lens optical system L into two by a plane that passes through the optical axis, and include the aperture area defined by the stop s. By adjusting the stop s, the light that has come from the subject enters either the region D1 or the region D2.

FIG. 2 is a front view of the stop S as viewed from the subject side. The arrows shown in FIGS. 1 and 2 indicate the horizontal direction when this image pickup device is used. At the stop S, the regions D1 and D2 have been horizontally (vertically in FIG. 2) divided into two in a plane that intersects with the optical axis V0 at right angles with the optical axis V0 defined to be the center of the boundary. In other words, these regions D1 and D2 are arranged at mutually different locations in the y direction within the plane that intersects with the optical axis V0 at right angles (which may be a plane that is parallel to the image capturing plane Ni of the image sensor N, for example). Also, V1 and V2 indicate the centers of mass of the regions D1 and D2, respectively, and the distance B between V1 and V2 corresponds to the base line length when the image is viewed with both eyes.

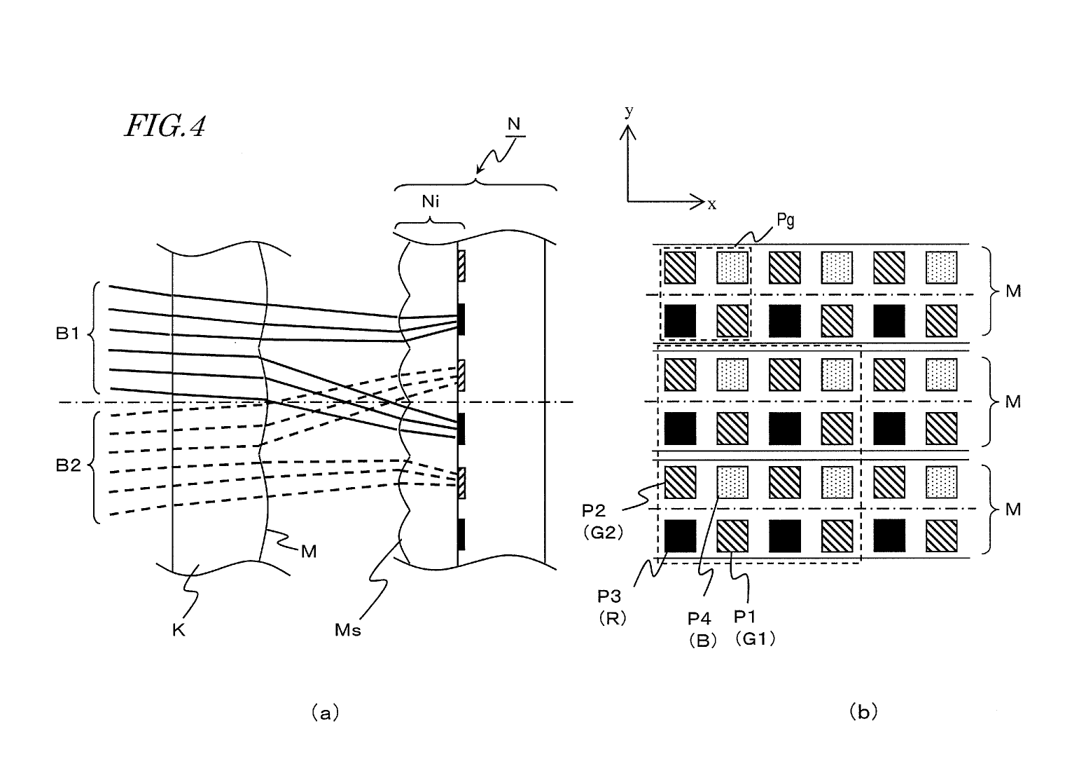

In FIG. 1, the bundle of rays B1 passes through the region D1 in the stop S, while the bundle of rays B2 passes through the region D2 in the stop s. These bundles of rays B1 and B2 pass through the stop S, the objective lens L1 and the array of optical elements K in this order to reach the image capturing plane Ni (shown in FIG. 4) on the image sensor N.

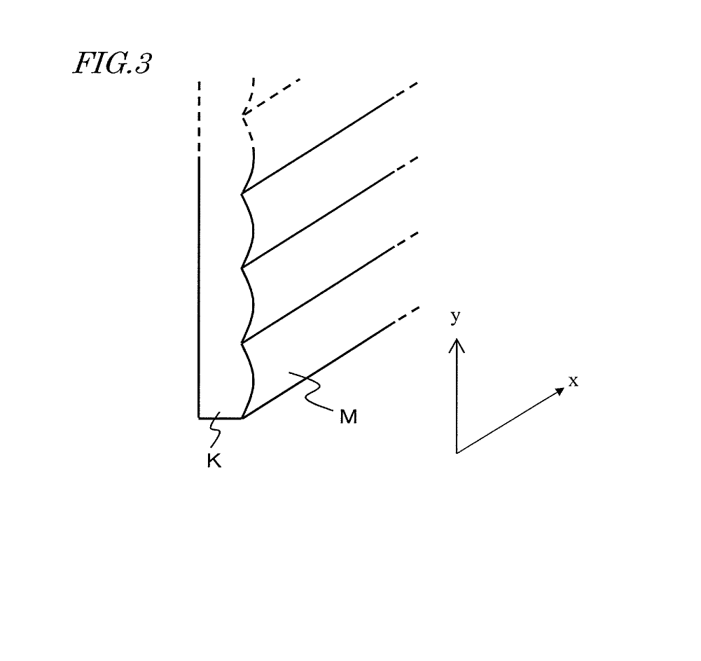

FIG. 3 is a perspective view of the array of optical elements K, which includes a plurality of optical elements M, each having a lens face. In this embodiment, the lens face of each optical element M is a cylindrical face. On one side of the array of optical elements K that faces the image sensor N, a plurality of optical elements M which are elongate in the x direction (i.e., the first direction) are arranged in the y direction (i.e., the second direction). In this embodiment, the x and y directions intersect with each other at right angles. A cross section of each optical element M as viewed on a plane that intersects with the x direction at right angles has a curved shape which projects toward the image sensor N. In this manner, in the array of optical elements K, these optical elements M form a lenticular lens.

FIG. 4(a) is an enlarged view of the array of optical elements K and image sensor N shown in FIG. 1. The array of optical elements K is arranged so that its side with the optical elements M faces the image capturing plane Ni. As shown in FIG. 1, the array of optical elements K is arranged in the vicinity of the focal point of the lens optical system L and is located at a predetermined distance from the image capturing plane Ni. The position at which the array of optical elements K is arranged may be determined by reference to the focal point of the objective lens L1, for example.

FIG. 4(b) shows the relative positions of the optical elements M in the array of optical elements K and pixels on the image sensor N. The image sensor N has a plurality of pixels which are arranged on the image capturing plane Ni. As shown in FIG. 4(b), those pixels are arranged two-dimensionally in the x and y directions. The plurality of pixels may be classified into four kinds of pixels P1, P2, P3 and P4. If an arrangement in the x direction is called a “row” and if an arrangement in the y direction is called a “column”, the pixels P1, P2, P3 and P4 are arranged in two rows and two columns on the image capturing plane Ni, and each set of these four pixels forms a group of pixels Pg. And a number of such groups of pixels Pg are arranged in the x and y directions over the image capturing plane Ni.

The array of optical elements K is arranged so that each single optical element M thereof is associated with two rows of pixels on the image capturing plane Ni. In other words, each single optical element M is arranged at a position corresponding to a group of pixels that are arranged in a row in the x direction among those multiple groups of pixels Pg. And on a plan view which intersects with the optical axis at right angles, each single optical element M is arranged so as to overlap with a group of pixels Pg that are arranged in a row in the x direction. The array of optical elements K makes most of the light that passed through the region D1 incident on the pixels P1 and P3 on the image sensor N and makes most of the light that passed through the pupil region D2 incident on the pixels P2 and P4 on the image sensor N.

The array of optical elements K has the function of selectively determining the outgoing direction of an incoming light beam according to its angle of incidence. That is why the array of optical elements K can make light incident onto pixels on the image capturing plane Ni so that the pattern of the light beams incident on the image capturing plane Ni corresponds to the regions D1 and D2 that have been divided by the stop S. To make light beams incident on those pixels in this manner, various parameters such as the refractive index of the array of optical elements K, the distance from the image capturing plane Ni, and the radius of curvature on the surface of the optical elements M just need to be set appropriately.

On the image capturing plane Ni, micro lenses Ms are arranged so as to cover the surface of respective pixels.

The pixels P1 and P2 are provided with a filter having a first spectral transmittance characteristic so as to mostly transmit a light beam falling within the color green wavelength range and absorb a light beam falling within any other wavelength range. Meanwhile, the pixel P3 is provided with a filter having a second spectral transmittance characteristic so as to mostly transmit a light beam falling within the color red wavelength range and absorb a light beam falling within any other wavelength range. And the pixel P4 is provided with a filter having a third spectral transmittance characteristic so as to mostly transmit a light beam falling within the color blue wavelength range and absorb a light beam falling within any other wavelength range.

The pixels P1 and P3 are alternately arranged in the x direction, so are the pixels P2 and P4. The pixels P1 and P4 are alternately arranged in the y direction, so are the pixels P2 and P3. The pixels P1 and P3 are arranged on the same row, so are the pixels P2 and P4, and the row of the pixels P1 and P3 and the row of the pixels P2 and P4 are alternately arranged in the y direction. In this manner, these pixels form a Bayer arrangement. As will be described later, these pixels do not have to form a Bayer arrangement but may be arranged in any other pattern as long as the pixels P1 and P2 having the same spectral transmittance characteristic are arranged at mutually different locations in the y direction (i.e., in the direction in which parallax is produced) within each group of pixels Pg.

In this embodiment, all of these pixels P1, P2, P3 and P4 have the same shape on the image capturing plane Ni. For example, the first kind of pixels P1 and the second kind of pixels P2 have the same rectangular shape and have the same area. Also, if these pixels are looked at on a row basis, the respective locations of each pair of pixels on two rows that are adjacent to each other in the y direction do not shift from each other in the x direction. Likewise, if these pixels are looked at on a column basis, the respective locations of each pair of pixels on two column that are adjacent to each other in the x direction do not shift from each other in the y direction.

Next, it will be described in what flow the first signal processing section C1 generates first and second color images.

FIG. 5 shows a flow in which the first signal processing section C1 generates first and second color images. In Step S101A shown in FIG. 5, color green (one primary color) image information G1 formed by the pixels P1 and color red image information R formed by the pixels P3 are generated. In Step S101B, color green image information G2 formed by the pixels P2 and color blue image information B formed by the pixels P4 are generated. Also, since the respective pixels are alternately arranged in the x direction as shown in FIG. 4, information about missing colors is complemented with the color information of adjacent pixels. As for the y direction, since the pixel information is missing every other column, the missing pixel information is complemented with the information about adjacent pixels.

In this case, the image information G1 and the image information G2 have the same spectral information and represent two images produced by imaging light beams that have passed through mutually different pupil regions. As a result, images with parallax are generated. This parallax Px is extracted in Step 102 shown in FIG. 5. Specifically, in Step 102, the parallax produced between a predetermined image block (representing a base image) in the image information G1 and another predetermined image block (representing a reference image) in the image information G2 is extracted by pattern matching. In carrying out pattern matching, the degree of correlation is obtained by an evaluation function called “SAD”, which is the sum of the absolute differences in pixel intensity between the base image and the reference image. Supposing the calculation block size of the small area is given by m×n pixels, the SAD is calculated by the following Equation (1):

$$SAD = {\sum }_{i = 0}^{m - 1} {\sum }_{j = 0}^{n - 1} I 0 ( x + i , y + j ) - I 1 ( x + dx + i , y + j ) \qquad ( 1 )$$

where x and y represent the coordinates on the image capturing plane and I0 and I1 respectively represent the intensity values in the base and reference images, of which the locations are specified by the coordinates in the parentheses.

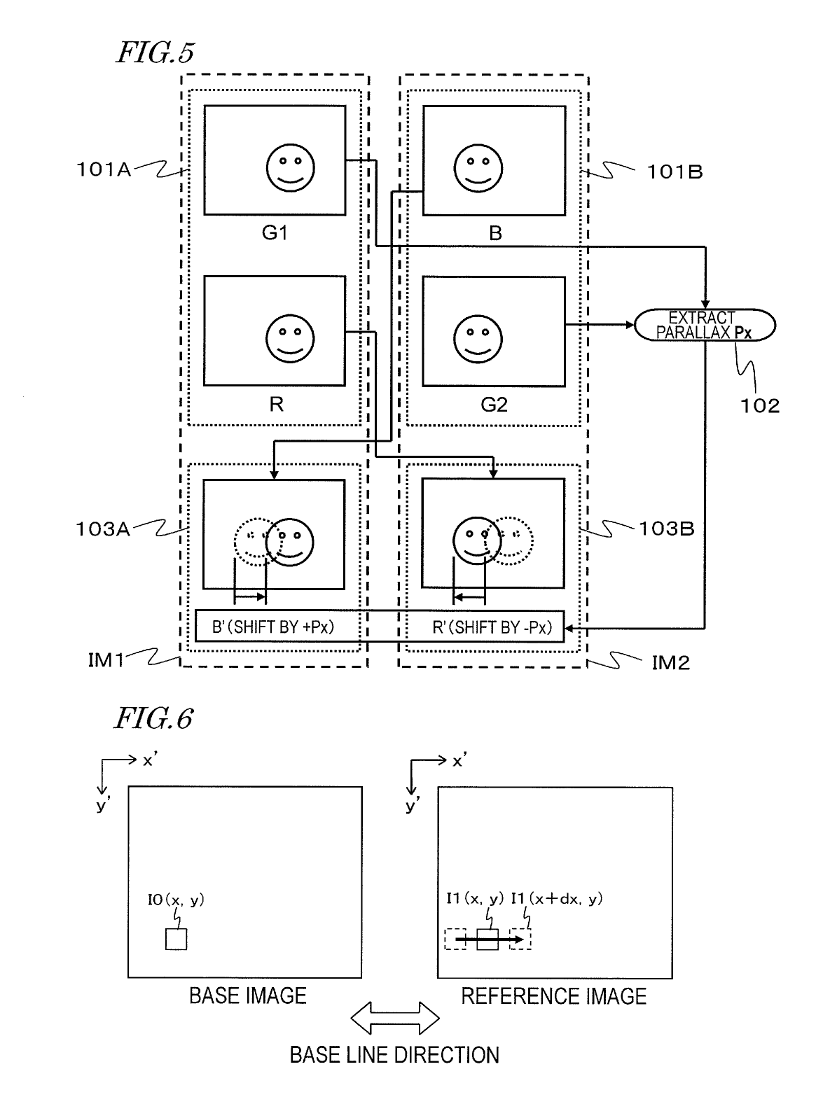

FIG. 6 illustrates how to calculate the SAD. The SAD is calculated with the reference image's search block area shifted by dx in the base line direction with respect to the base image's base block area as shown in FIG. 6. And dx associated with a local minimum SAD becomes the parallax Px. As the SAD can be calculated at an arbitrary set of coordinates, the parallax can be extracted from the entire field of view to be imaged. In Step S102, the parallax Px is extracted on a small area basis over the entire image.

Next, in Step 103A shown in FIG. 5, the color blue image information B that has been generated in Step 101B is shifted in the positive direction by the parallax Px that has been extracted in Step 102. By doing this on a small area basis over the entire image, color blue image information B′ is generated. As a result, a first color image IM1 comprised of (i.e., including as respective components) the color green image information G1, the color red image information R and the color blue image information B′ is generated. In the same way, in Step 103B shown in FIG. 5, the color red image information R that has been generated in Step 101A is shifted in the negative direction by the parallax Px that has been extracted in Step 102. By doing this on a small area basis over the entire image, color red image information R′ is generated. As a result, a second color image IM2 comprised of (i.e., including as respective components) the color green image information G2, the color blue image information B and the color red image information R′ is generated.

Now let us compare the amount of information of an image in a predetermined area to a comparative example. FIGS. 21(a) and 21(b) show the image information yet to be interpolated for first and second color images that have been extracted from the 4×4 pixel image area at the lower left corner shown in FIG. 20(b) as a comparative example. As shown in FIGS. 21(a) and 21(b), in each of the extracted areas, the amount of information about the color green is four pixels and the amount of information about the colors red and blue is two pixels. By complementing information about pixels missing from these pieces of image information, color images can be generated.

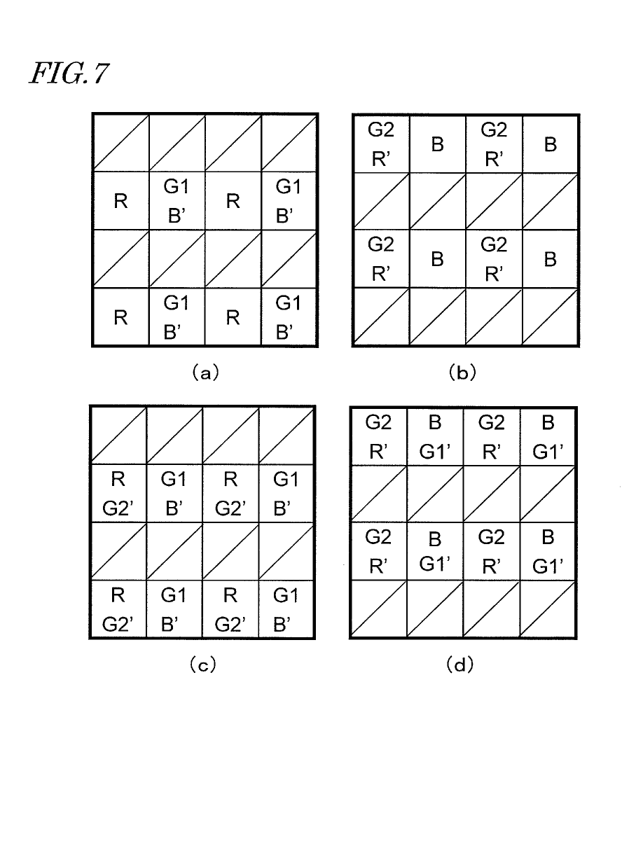

FIGS. 7(a) and 7(b) show the image information yet to be interpolated for first and second color images that have been extracted from the 4×4 pixel image area at the lower left corner shown in FIG. 4(b). As shown in FIGS. 7(a) and 7(b), in each of the extracted areas, the amount of information about the colors red, green and blue is four pixels. By complementing information about pixels missing from these pieces of image information, color images can be generated.

Comparing this embodiment to the comparative example, it can be seen that the amount of information about the color green image is the same but the amount of information about the colors red and blue images according to this embodiment is twice as large as in the comparative example. Consequently, the resolution of the color images to be generated by complementing can be increased.

As can be seen, according to this embodiment, first and second color images with a high resolution can be obtained by using a single image pickup system. The first and second color images can be handled as an image to be viewed with the right eye and an image to be viewed with the left eye, respectively. Consequently, by displaying the first and second color images on a 3D monitor, the object can be viewed as a stereoscopic image.

In addition, since images to make the viewer sense a stereoscopic image of the subject can be obtained by using a single image pickup system, there is no need to adjust the characteristics or positions of multiple imaging optical systems unlike an image pickup device with multiple imaging optical systems.

On top of that, since an image sensor with an ordinary Bayer arrangement may be used as an image sensor according to this embodiment, photomasks for forming color filters with a dedicated filter arrangement no longer need to be used, and therefore, the initial equipment cost can be cut down.

Optionally, by performing similar processing steps to the ones shown in FIG. 5, image information G2′ and image information G1′ may also be obtained by shifting the color green image information G2 by the parallax Px in the positive direction and by shifting the color green image information G1 by the parallax Px in the negative direction, respectively. As in FIGS. 7(a) and 7(b), if the image information yet to be interpolated for first and second color images is extracted from the 4×4 pixel image area at the lower left corner shown in FIG. 4(b), the results will be as shown in FIGS. 7(c) and 7(d). In this case, the color green image information that has been generated by complementing before the parallax is extracted is replaced with image information obtained by shifting by the parallax Px. According to the results shown in FIGS. 7(c) and 7(d), in each of the extracted areas, the amount of information about the colors red and blue is four pixels, and the amount of information about the color green is eight pixels. Consequently, color images with an even higher resolution can be generated.

Also, the optical system of the image pickup device of this embodiment may be an image-space telecentric optical system. In that case, even if the angle of view changes, the principal ray will also be incident on the array of optical elements K at an angle of incidence of nearly zero degrees. As a result, crosstalk between the bundle of rays impinging on the pixels P1 and P3 and the bundle of rays impinging on the pixels P2 and P4 can be reduced over the entire image capturing area.

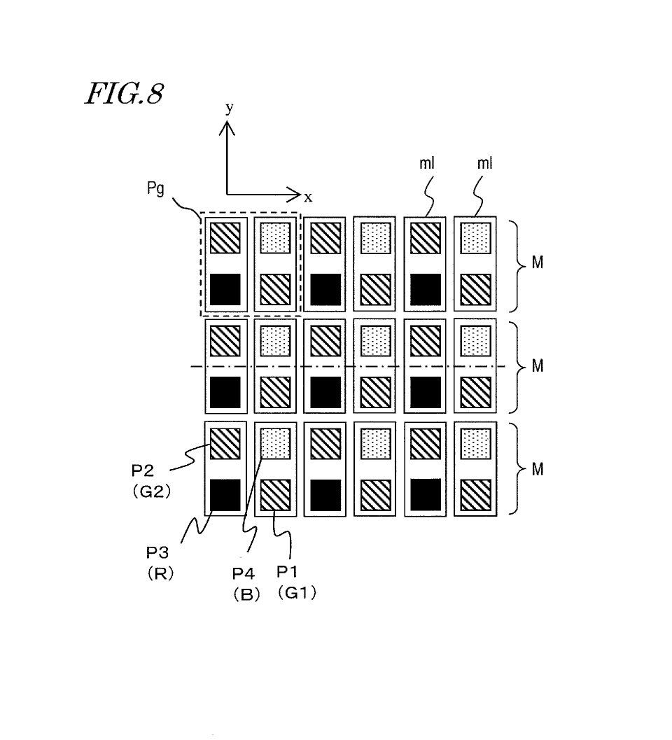

Furthermore, in the embodiment described above, the optical elements M of the array of optical elements K are supposed to be a lenticular lens. However, the optical elements M may also be an array of micro lenses, each covering two pixels as shown in FIG. 8. As shown in FIG. 8, each of the micro lenses ml is arranged at such a position as to face two pixels that are arranged in the y direction. In other words, on a plan view that intersects with the optical axis at right angles, each micro lens ml is arranged so as to overlap with two pixels that are arranged in the y direction. Each of the multiple optical elements M is comprised of a plurality of micro lenses ml which are arranged in the x direction. Even in the arrangement shown in FIG. 8, each single optical element M is arranged at such a position as to face a group of pixels that are arranged in a row in the x direction as in the arrangement shown in FIG. 4.

### Embodiment 2

According to a second embodiment, an array optical elements is arranged on the image capturing plane, which is a major difference from the first embodiment described above. In the following description of this second embodiment, common features between this and first embodiments will not be described in detail all over again.

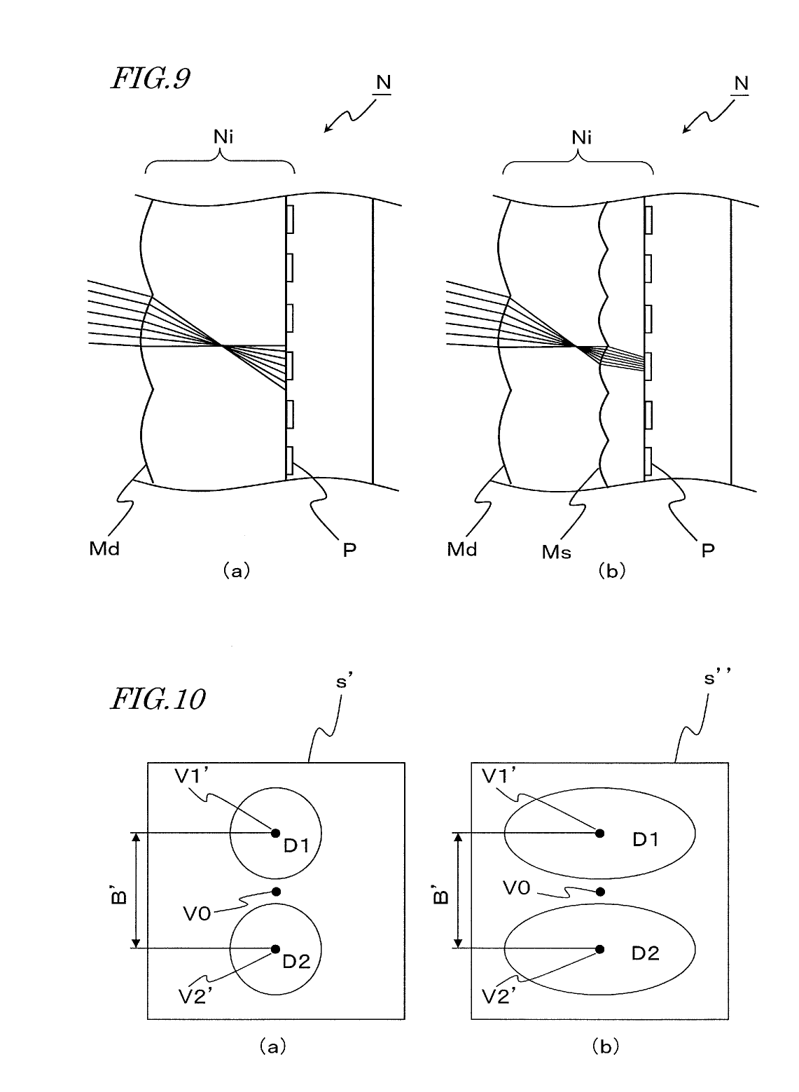

FIG. 9(a) is an enlarged view of an array of optical elements K and image sensor N according to this embodiment. In this embodiment, the optical elements Md of the array of optical elements K have been formed on the image capturing plane Ni of the image sensor N. As in the first embodiment described above, a number of pixels are arranged in columns and rows on the image capturing plane Ni. Those pixels are also associated with a single optical element Md. In this embodiment, light beams which have been transmitted through different regions of the stop S can be guided to different pixels as in the first embodiment described above. FIG. 9(b) illustrates a modified example of this embodiment. In the arrangement shown in FIG. 9(b), micro lenses Ms have been formed on the image capturing plane Ni so as to cover the pixels P and an array of optical elements is stacked on the surface of the micro lenses Ms. By adopting the arrangement shown in FIG. 9(b), the incoming light can be condensed more efficiently than in the arrangement shown in FIG. 9(a).

### Embodiment 3

According to a third embodiment, the regions D1 and D2 are spaced apart from each other with a predetermined gap left between them unlike the first and second embodiments described above. In the following description of this third embodiment, common features between this and first embodiments will not be described in detail all over again.

FIG. 10(a) is a front view of a stop S′ as viewed from the subject side. The regions D1 and D2 defined by the stop S′ both have a circular shape and are separated from each other. V1′ and V2′ indicate the respective centers of mass of the regions D1 and D2, and the distance B′ between V1′ and V2′ corresponds to the base line length in viewing with right and left eyes. According to this embodiment, the base line length B′ can be greater than B of the first embodiment shown in FIG. 2, and therefore, the impression of depth can be increased when the viewer is viewing a stereoscopic image on a 3D monitor. On top of that, even though the light passing near the boundary between the regions D1 and D2 could cause crosstalk if the regions D1 and D2 are not separated as in the first embodiment, the crosstalk can be reduced by separating the regions D1 and D2 from each other as is done in this embodiment.

Optionally, the aperture shape of the regions D1 and D2 may be elliptical ones as in the stop S″ shown in FIG. 10(b). By adopting such an elliptical aperture shape, the quantity of light passing through each region can be increased and eventually the sensitivity of the image can be increased compared to FIG. 9(a).

### Embodiment 4

According to a fourth embodiment, the positions of the regions D1 and D2 separated by the stop can be changed, which is a major difference from the third embodiment described above. In the following description of this fourth embodiment, common features between this and third embodiments will not be described in detail all over again.

According to this fourth embodiment, the stop Sv is implemented as a liquid crystal shutter array and the positions of the regions D1 and D2 can be changed by switching the aperture positions of the liquid crystal shutter array as shown in FIGS. 11(a) through 11(c). The liquid crystal shutter array may be made of a transmission type liquid crystal material such as an ordinary TN (twisted nematic) liquid crystal material.

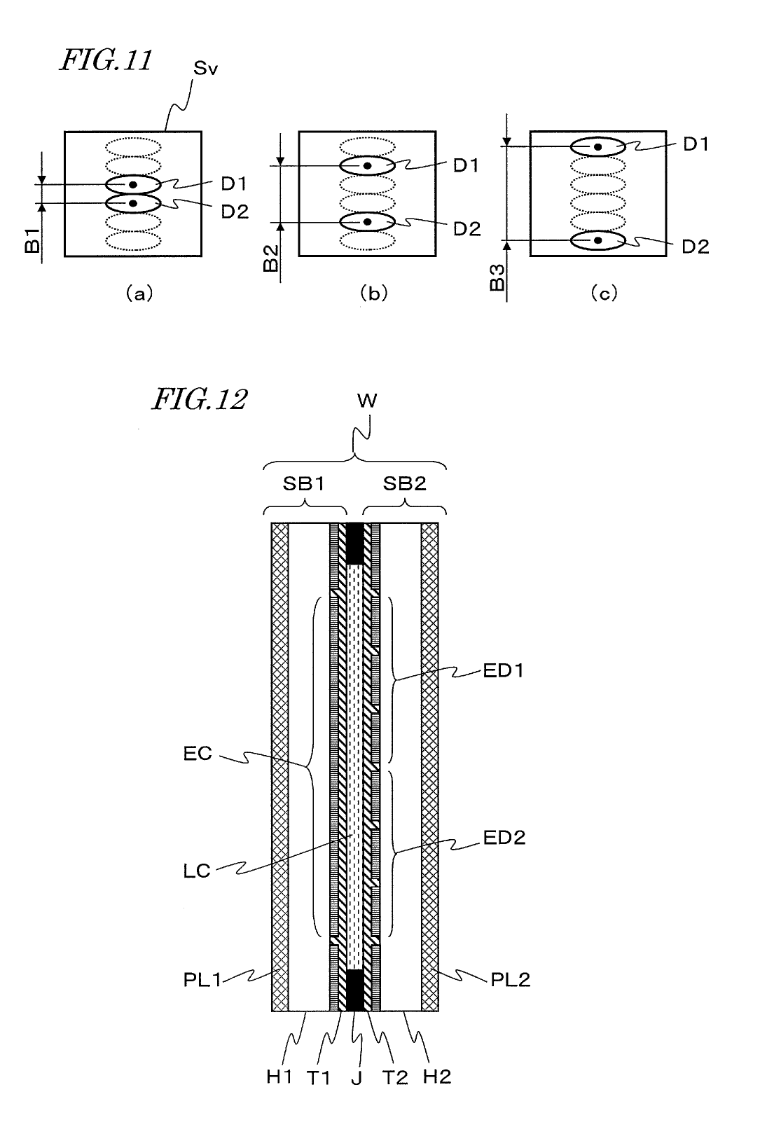

FIG. 12 is a cross-sectional view of the liquid crystal shutter array W. In the liquid crystal shutter array W, two substrates SB1 and SB2 are bonded together with a seal member J and a liquid crystal material LC is injected thereto. The substrate SB1 is comprised of a polarizer PL1, a glass plate H1, a common electrode EC and an alignment film T1. On the other hand, the substrate SB2 is comprised of a polarizer PL2, a glass plate H2, a group of electrodes ED1 and ED2 which choose a pupil region, and an alignment film T2. This liquid crystal shutter array operates in normally black mode and is configured to transmit incoming light when the drive voltage is ON and cut the light when the drive voltage is OFF.

In FIGS. 11(a), 11(b) and 11(c), the base line lengths become B1, B2 and B3, respectively, and the aperture positions can be changed by turning ON and OFF the respective liquid crystal shutters.

Since the aperture positions can be changed, the depth of the image can be appropriately selected according to the subject distance.

In this embodiment, the base line lengths are supposed to be changeable in three stages as shown in FIGS. 11(a) through 11(c). However, the base line lengths may also be changed in two stages or in four or more stages. Optionally, the respective liquid crystal shutters may have a circular or rectangular shape, too.

### Embodiment 5

According to a fifth embodiment, the positions of the regions D1 and D2 that are separated from each other by the stop can be changed with an even higher resolution, which is a major difference from the fourth embodiment described above.

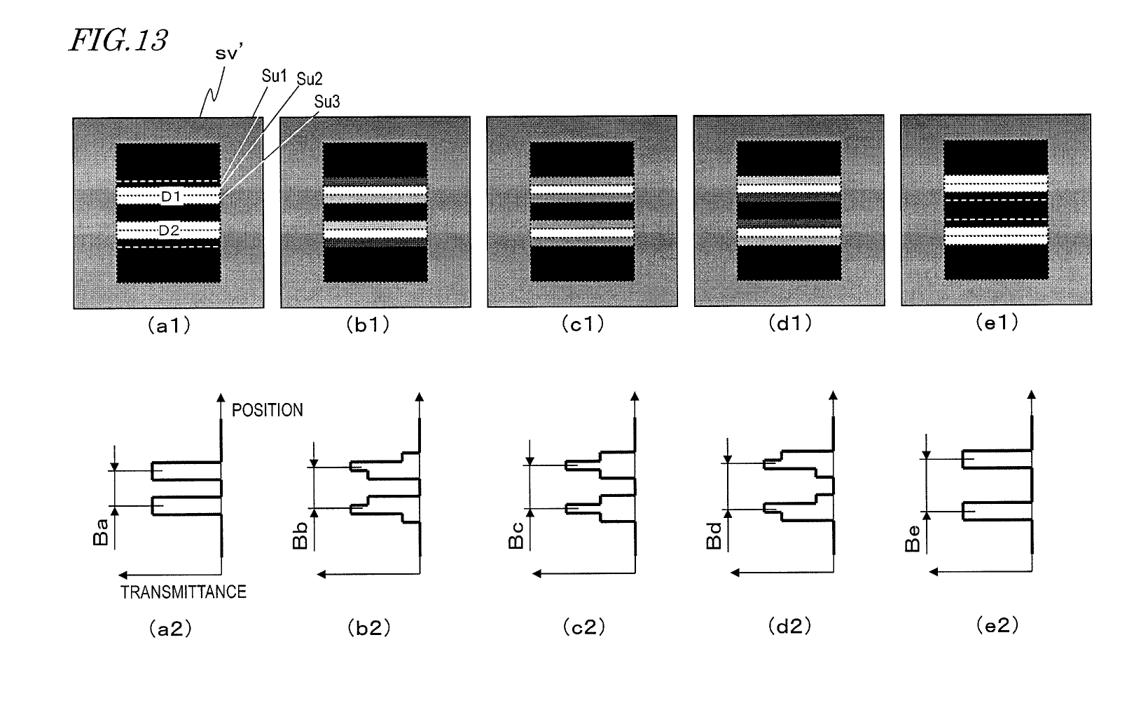

According to this fifth embodiment, the stop Sv′ is implemented as a liquid crystal shutter array as shown in FIGS. 13(a1) through 13(e1). And the liquid crystal shutter array has apertures to define the regions D1 and D2. Each of the regions D1 and D2 has a plurality of sub-regions. In FIGS. 13(a1) through 13(e1), shown are only three Su1, Su2 and Su3 of the sub-regions that each of the regions D1 and D2 has for the sake of simplicity. However, each of these regions D1 and D2 may naturally have additional sub-regions other than those three sub-regions Su1, Su2 and Su3.

In each of these sub-regions Su1, Su2 and Su3 shown in FIGS. 13(a1) through 13(e1), the transmittance of the liquid crystal shutter is controlled. Thus, the respective barycenters of the transmittance distributions of the regions D1 and D2 can be changed. FIGS. 13(a2) through 13(e2) are graphs showing the respective transmittances of the liquid crystal shutters and corresponding to FIGS. 13(a1) through 13(e1), respectively.

In FIGS. 13(a2) through 13(e2), the respective barycenters of the transmittance distributions of the regions D1 and D2 correspond to the respective centers of mass of the apertures of the regions D1 and D2, respectively. And the base line lengths, which are measured between the centers of mass of the apertures of the respective regions D1 and D2, become distances Ba through Be.

To increase the resolution of the base line length using two-stage liquid crystal shutters to be either turned ON or OFF as is done in the fourth embodiment, the number of the liquid crystal shutters to provide needs to be increased, too. However, the larger the number of liquid crystal shutters to provide, the lower the aperture ratio of the liquid crystal shutters and the lower the transmittances of the regions D1 and D2. As a result, the sensitivity of the image also decreases eventually, which is not beneficial.

On the other hand, by using multi-stage liquid crystal shutters as is done in this embodiment, the resolution of the base line length can be increased even with a small number of liquid crystal shutters. In addition, since the decrease in the aperture ratio of the liquid crystal shutters can be minimized, the decrease in the transmittance of the regions D1 and D2 can be minimized, too. Consequently, the decrease in the sensitivity of the image can be avoided.

### Embodiment 6

According to a sixth embodiment, reflective members (reflective surfaces) 1A and 1B to make light incident on the region D1 are arranged on the lens optical system L, which is a major difference from the first through fifth embodiments. In the following description of this sixth embodiment, common features between this and first embodiments will not be described in detail all over again.

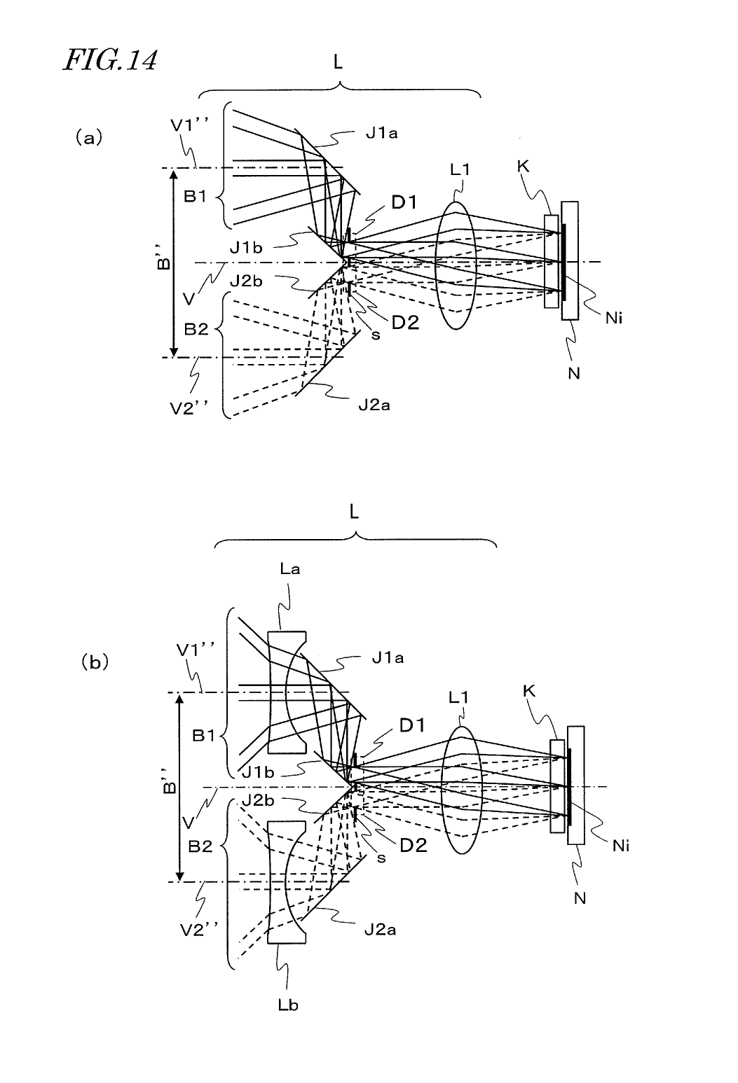

FIG. 14(a) is a schematic representation illustrating an optical system for an image pickup device A according to this sixth embodiment. In FIG. 14(a), a bundle of rays B1 passes through reflective surfaces J1a, J1b, the region D1 defined by the stop S, the objective lens L1 and the array of optical elements K in this order to impinge on the image capturing plane Ni on the image sensor N. On the other hand, a bundle of rays B2 passes through reflective surfaces J2a, J2b, the region D2 defined by the stop S, the objective lens L1 and the array of optical elements K in this order to impinge on the image capturing plane Ni on the image sensor N. Also, V1″ and V2″ indicate the optical axes for viewing with right and left eyes and the distance B″ between V1″ and V2″ corresponds to the base line length in the case of viewing with right and left eyes.

According to this embodiment, high-resolution color images for stereoscopic viewing can be obtained using a single lens optical system. In addition, by folding the optical paths leading to the respective regions D1 and D2 at the reflective surfaces, the base line length can be extended, and the image can have its depth increased when viewed as a stereoscopic image on a 3D monitor.

Although the reflective surfaces are mirrors in FIG. 14(a), prisms may be used instead.

Still alternatively, a concave lens may be arranged in front of each of the reflective surfaces J1a and J2a as shown in FIG. 14(b). By arranging the concave lens, the angle of view can be increased with the base line length maintained. Or the base line length may be shortened with the angle of view maintained.

In this description, a “single image pickup system” refers herein to an optical system which is configured so that a lens optical system's objective lens (except the array of optical elements) produces an image on a single primary imaging plane, which refers herein to a plane on which the light that has entered that objective lens produces an image for the first time. The same statement applies to every embodiment other than this. In this embodiment, in both of FIGS. 14(a) and 14(b), there is the primary imaging plane on or near the image capturing plane Ni.

### Embodiment 7

According to a seventh embodiment, the lens optical system includes an objective lens and a relay optical system, which is a major difference from the first through sixth embodiments described above. In the following description of this seventh embodiment, common features between this and first embodiments will not be described in detail all over again.

FIG. 15 is a schematic representation illustrating an optical system for an image pickup device A according to this sixth embodiment. As shown in FIG. 15, the optical system Os of this embodiment is comprised of a stop S, an objective lens L1 and a relay optical system LL. The stop S and the objective lens L1 form a lens optical system L. Meanwhile, the relay optical system LL is made up of first and second relay lenses LL1 and LL2. Such a relay optical system LL can sequentially produce intermediate images Im1 and Im2 according to the number of relay lenses. By arranging such a relay optical system LL between the objective lens L1 and the array of optical elements K, the optical length can be extended with the focal length maintained. As a result, even when the optical length needs to be extended by such a relay optical system LL as in a rigid endoscope, a stereoscopic image can also be viewed with a single optical system.

If a stereoscopic image is viewed with a pair of optical systems arranged as in a conventional method, the optical properties of a pair of lens optical system need to be matched to each other, so are the optical properties of a pair of relay optical systems. However, since such an optical system needs a great many lenses, it is very difficult to match their properties to each other between the optical systems. In contrast, since a single optical system is used according to this embodiment as described above, the properties of the optical systems no longer need to be matched to each other, and therefore, the assembling process can be simplified.

Although the relay optical system LL is comprised of two relay lenses LL1 and LL2 in FIG. 15, the relay optical system LL does not have to be made up of two relay lenses. Optionally, a field lens may be arranged at a position where an intermediate image is produced on the optical path.

According to this embodiment, high-resolution color images for stereoscopic viewing can also be obtained using a single image pickup system. Specifically, in this embodiment, the first relay lens LL1 produces an intermediate image Im2 based on the intermediate image Im1 that has been produced by the objective lens L, and the second relay lens LL2 produces an image on the image capturing plane Ni based on the intermediate image Im2. In the objective lens L, the intermediate image Im1 is produced on the primary imaging plane. According to this embodiment, an image is produced by the objective lens L on a single primary imaging plane.

### Embodiment 8

According to an eighth embodiment, a signal processing section which measures the distance to the object is used, which is a major difference from the first through seventh embodiments described above.

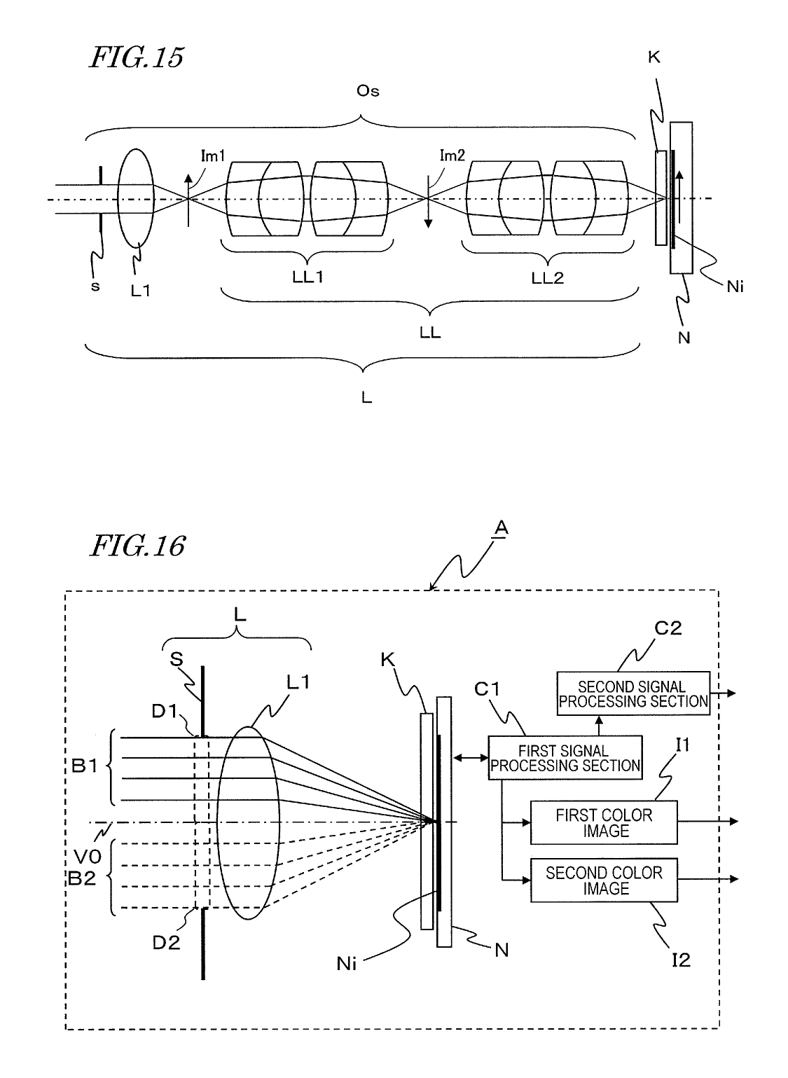

FIG. 16 is a schematic representation illustrating an optical system for an image pickup device A according to this eighth embodiment. The configuration of this embodiment includes not only everything of the first embodiment but also a second signal processing section C2 which measures the distance to the object. In the other respects, however, this embodiment is quite the same as the first embodiment, and detailed description thereof will be omitted herein.

The second signal processing section C2 calculates the distance to the subject based on the parallax Px that has been extracted by the first signal processing section.

Hereinafter, it will be described how to calculate the distance to the subject based on the parallax Px extracted.

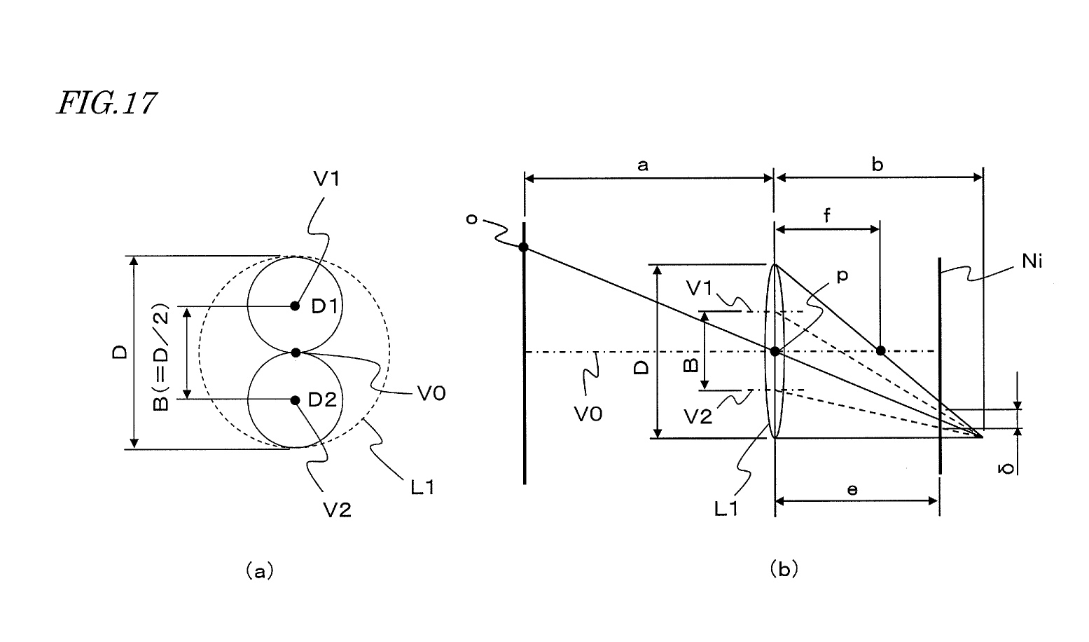

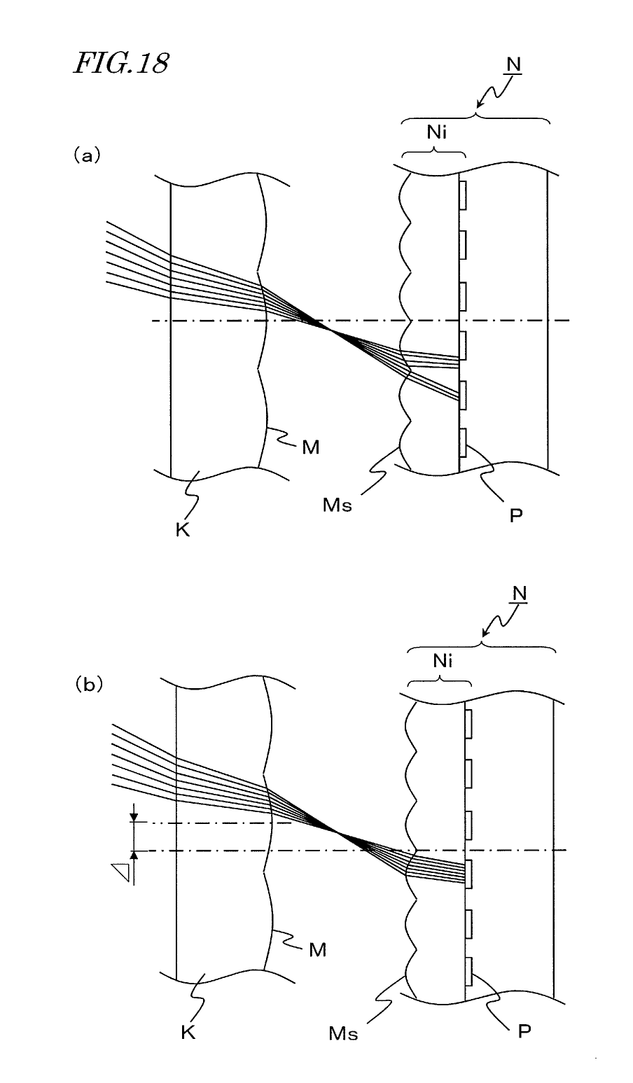

FIGS. 17(a) and 17(b) illustrate conceptually the principle of rangefinding according to this embodiment. In this example, an ideal optical system including a thin lens is supposed to be used to describe the basic principle of rangefinding simply. FIG. 17(a) is a front view of the regions D1 and D2 as viewed from the subject side. In FIG. 17(a), the respective reference signs mean the same as in FIG. 2. To describe the principle simply, the size of the regions D1 and D2 is supposed to be a half as large as the diameter of the objective lens L1 and the base line length B is also supposed to be a half as long as the diameter of the objective lens L1. The regions D1 and D2 are supposed to be present in a plane including the principal point of the objective lens L1, and the regions other than these regions D1 and D2 are supposed to be shielded from light. Also, illustration of the array of optical elements is omitted for the sake of simplicity. FIG. 17(b) shows the optical path of the optical system. In FIG. 17(b), “o” indicates the object point, “p” indicates the principal point of the objective lens L1, “i” indicates the image capturing plane, indicates the distance from the object point o to the principal point p of the objective lens L1 (i.e., the subject distance), indicates the distance as measured in the optical axis direction from the principal point p of the objective lens L1 to the imaging point, “f” indicates the focal length, and “e” indicates the distance from the principal point to the image capturing plane Ni. In this case, according to the lens formula, the following Equation (2) is satisfied:

$$\frac{1}{a} + \frac{1}{b} = \frac{1}{f} \qquad ( 2 )$$

Also, in FIG. 17(b), δ(=Px) indicates the parallax on the image capturing plane between the light beams that have passed through the regions D1 and D2 of the objective lens L1. In this case, considering the geometric relation of the optical path, the following Equation (3) is satisfied:

$$\frac{B}{b} = \frac{δ}{b - e} \qquad ( 3 )$$

Based on these Equations (2) and (3), the subject distance a can be calculated by the following Equation (4):

$$a = \frac{1}{\frac{1}{e} ( \frac{δ}{B} - 1 ) + \frac{1}{f}} \qquad ( 4 )$$

In Equation (4), the focal length f and the base line length B are already known, the parallax δ is extracted by pattern matching described above, and the distance e from the principal point to the image capturing plane i varies according to the setting of focusing length. However, if the focusing length is fixed, then “e” also becomes a constant, and therefore, the subject distance a can be calculated.

Also, if e=f is substituted for Equation (4) and if the focusing length is set to be infinity, then Equation (4) is transformed into the following Equation (5):

$$a = \frac{fB}{δ} \qquad ( 5 )$$

This Equation (5) becomes the same as the equation of triangulation that uses a pair of imaging optical systems that are arranged parallel to each other.

By making these calculations, the distance to a subject that has been captured at an arbitrary position on a given image or information about the distance to a subject over the entire image can be obtained by a single imaging optical system.

### Other Embodiments

In the first through eighth embodiments described above, the objective lens L1 is supposed to be a single lens. However, the objective lens L1 may also be made up of either multiple groups of lenses or multiple lenses.

Furthermore, in the first through eighth embodiments described above, the lens optical system L is supposed to be an image-space telecentric optical system. However, the lens optical system L may also be an image-space non-telecentric optical system as well. FIG. 18(a) illustrates, on a larger scale, an image capturing section and its surrounding members in such a situation where the lens optical system L is an image-space non-telecentric optical system. In FIG. 18(a), among the light that passes through the array of optical elements K, only a bundle of rays that passes through the region D1 is shown. As shown in FIG. 18(a), if the lens optical system L is an image-space non-telecentric optical system, light will leak onto adjacent pixels to cause crosstalk easily. However, by offsetting the array of optical elements with respect to the pixel arrangement by Δ as shown in FIG. 18(b), the crosstalk can be reduced. As the angle of incidence varies with the image height, the magnitude of offset Δ may be determined according to the angle of incidence of the bundle of rays onto the image capturing plane. By adopting such an image-space non-telecentric optical system, the optical length can be shortened, and therefore, the size of the image pickup device A can be reduced, compared to a situation where an image-space telecentric optical system is adopted.

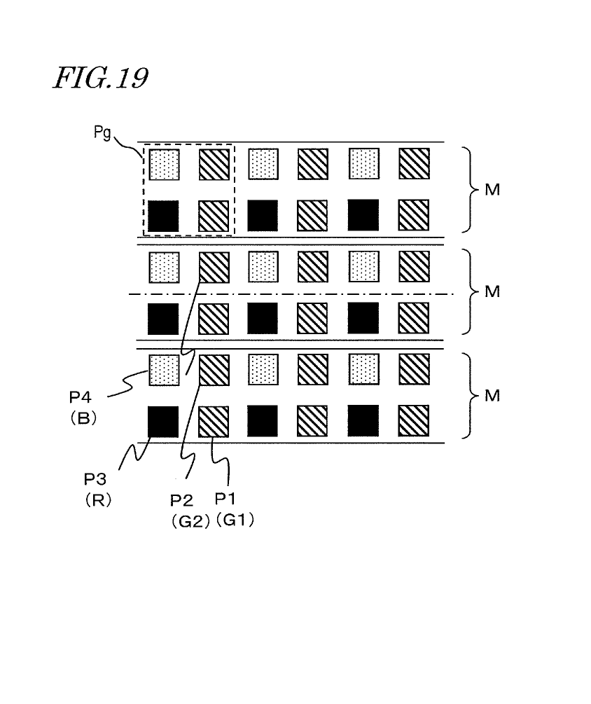

Also, although the pixel arrangement of the image sensor is supposed to be a Bayer arrangement in the embodiments described above, a pixel arrangement such as the one shown in FIG. 19 may also be adopted. Specifically, in the arrangement shown in FIG. 19, the first and second pixels that transmit a light beam falling within the first wavelength range are not arranged diagonally but arranged on the same column within each group of pixels Pg. If the image sensor N with the Bayer arrangement is adopted, the direction shifting by the parallax Px in Step 103A shown in FIG. 5 is opposite to the direction of shifting by the parallax Px in Step 103B. On the other hand, according to the arrangement shown in FIG. 19, shifting by the parallax Px may be carried out in the same direction in these processing steps 103A and 103B.

Even if such a pixel arrangement is adopted, first and second color images can also be generated following the flow shown in FIG. 5.

Each of the first through seventh embodiments is an image pickup device including a first signal processing section C1, and the eighth embodiment is an image pickup device further including a second signal processing section C2. However, an image pickup device according to the present invention may include none of these signal processing sections. In that case, the processing that should be carried out by the first and second signal processing sections C1 and C2 may be performed by a PC provided outside of the image pickup device. That is to say, the present invention may also be implemented as a system including an image pickup device with an objective lens L, an array of optical elements K and an image sensor N and an external signal processor.

### INDUSTRIAL APPLICABILITY

An image pickup device according to the present disclosure can be used effectively as a digital still camera or a digital camcorder, for example. In addition, the image pickup device of the present disclosure is also applicable to a distance measuring device for monitoring the environment surrounding a car or the crew in a car and to viewing a stereoscopic image on, or entering 3D information to, game consoles, PCs, mobile telecommunications devices, endoscopes, and so on.

### REFERENCE SIGNS LIST

A image pickup device
B1, B2 bundle of rays
V1 optical axis
L lens optical system
L1 objective lens
D1, D2 region (pupil region)
S stop
K array of optical elements
N image sensor
Ni image capturing plane
Ms micro lens on image sensor
M, Md optical elements in array of optical elements
P1 to P4 photodiodes (pixels) on image sensor
Pg group of pixels
C1, C2 first and second signal processing sections
Op optical system
SB1 substrate
SB2 substrate
Su1, Su2, Su3 sub-region
T1 alignment film
T2 alignment film
PL1 polarizer
PL2 polarizer
W liquid crystal shutter array
LL relay optical system
LL1 first relay lens
LL2 second relay lens

1. An image pickup device comprising:
a lens optical system which includes a first pupil region and a second pupil region that is different from the first pupil region;
an image sensor with multiple groups of pixels, in each of which first, second, third and fourth pixels, on which light that has passed through the lens optical system is incident, are arranged in two rows and two columns on an image capturing plane; and
an array of optical elements which is arranged between the lens optical system and the image sensor and which includes a plurality of optical elements,
wherein the multiple groups of pixels are arranged in first and second directions on the image capturing plane, and
wherein the first and second pixels have a first spectral transmittance characteristic, the third pixel has a second spectral transmittance characteristic, the fourth pixel has a third spectral transmittance characteristic, and in each said group of pixels, the first and second pixels are arranged at mutually different positions in the direction, and
wherein in the array of optical elements, each of the plurality of optical elements is arranged at such a position as to face groups of pixels that are arranged in a row in the first direction among the multiple groups of pixels.

2. The image pickup device of claim 1, wherein on a plane which is parallel to the image capturing plane of the image sensor, the first and second pupil regions are arranged at mutually different positions in the second direction.

3. The image pickup device of claim 1, wherein the array of optical elements makes light that has passed through the first pupil region incident on the first and third pixels and also makes light that has passed through the second pupil region incident on the second and fourth pixels.

4. The image pickup device of claim 1, further comprising a signal processing section,
wherein the signal processing section receives first and second pieces of image information that have been generated by the first and second pixels, respectively, extracts the magnitude of parallax between the first and second pieces of image information, and generates first and second color images with parallax based on the first, second, third and fourth pixels and the magnitude of parallax.

5. The image pickup device of claim 4, wherein the first and second color images are generated by shifting, by the magnitude of parallax, third and fourth pieces of image information that have been generated by the third and fourth pixels.

6. The image pickup device of claim 5, wherein the first color image includes, as its components, the first piece of image information, the third piece of image information, and a piece of image information obtained by shifting the fourth piece of image information by the magnitude of parallax, and
wherein the second color image includes, as its components, the second piece of image information, the fourth piece of image information, and a piece of image information obtained by shifting the third piece of image information by the magnitude of parallax.

7. The image pickup device of claim 4, wherein the first and second color images are generated by shifting, by the magnitude of parallax, the first, second, third and fourth pieces of image information that have been generated by the first, second, third and fourth pixels, respectively.

8. The image pickup device of claim 7, wherein the first color image includes, as its components, the first piece of image information, the third piece of image information, and a piece of image information obtained by shifting the second and fourth pieces of image information by the magnitude of parallax, and
wherein the second color image includes, as its components, the second piece of image information, the fourth piece of image information, and a piece of image information obtained by shifting the first and third pieces of image information by the magnitude of parallax.

9. The image pickup device of claim 1, wherein the first, second, third and fourth pixels of the image sensor are arranged in a Bayer arrangement pattern.

10. (canceled)

11. The image pickup device of claim 1, wherein the array of optical elements is a lenticular lens.

12. The image pickup device of claim 1, wherein the array of optical elements is a micro lens array, and
wherein each of the plurality of optical elements includes a plurality of micro lenses that are arranged in the first direction, and
wherein each of the plurality of micro lenses is arranged at such a position as to face two pixels that are arranged in the second direction.

13.-14. (canceled)

15. The image pickup device of claim 1, wherein the array of optical elements has been formed on the image sensor.

16. The image pickup device of claim 15, further comprising a micro lens which is arranged between the array of optical elements and the image sensor,
wherein the array of optical elements has been formed over the image sensor with the micro lens interposed.

17. The image pickup device of claim 1, further comprising a liquid crystal shutter array which changes the positions of the first and second pupil regions.

18. The image pickup device of claim 17, wherein each of liquid crystal shutters in the liquid crystal shutter array has a variable transmittance.

19. The image pickup device of claim 1, wherein the lens optical system further includes reflective members 1A and 1B which make light incident on the first pupil region and reflective members 2A and 2B which make light incident on the second pupil region.

20. The image pickup device of claim 1, further comprising a relay optical system.

21. The image pickup device of claim 1, further comprising a stop,
wherein the stop makes light that has come from the object incident on the first and second pupil regions.

22. A distance measuring device comprising:
the image pickup device of claim 1; and
a second signal processing section which measures the distance to the object.

23. An image pickup system comprising the image pickup device of claim 1 and a signal processor,
wherein the signal processor receives first and second pieces of image information that have been generated by the first and second pixels, respectively, extracts the magnitude of parallax between the first and second pieces of image information, and generates first and second color images with parallax based on the first, second, third and fourth pixels and the magnitude of parallax.
